(19) United States
(12) Patent Application Publication
(10) Pub. No.: US 2007/0166572 A1
(43) Pub. Date: Jul. 19, 2007

(54) Battery cover structure to identify the positive and negative poles of a battery

(76) Inventor: Jui-Chih Wang, Yung Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/334,441

(22) Filed: Jan. 19, 2006

(51) Int. Cl. H01M 2/34; H01M 2/04

(52) U.S. Cl. 429/1; 429/175

(57) ABSTRACT

A battery cover structure to identify the positive or negative poles of a battery has installed with identifiers at the location nearby conducting terminals. The identifiers are made with insulating plastics material in different colors or shapes inserted into the mold for injection. The differential colors or shapes make the identification of battery terminals and eliminate the dangerous of explosion due to error connection.

### BACKGROUND OF THE INVENTION

1. Field of the Invention

This invention relates to a battery cover, and more particularly to a battery cover embedded with identifiers close to conducting terminals, which enables to identify the positive or negative poles of a battery.

2. Description of the Prior Art

A conventional battery comprises a positive terminal and a negative terminal on a battery cover. As shown in FIG. 4, a battery cover A comprises a set of conducting terminals B. A cable C is provided with red and black insulating sleeves C1 which are connected to the terminals B of the battery cover A. When replacing the battery, sometimes the user may be confused with the positive and negative poles. A mistake connection is very danger; sometimes it may even cause a big explosion.

FIG. 5 shows a second embodiment of the prior art. A battery cover A has a pair of conducting terminals B, and a pair of signs D are formed next to the conducting terminals B, respectively. The signs D are marked with positive and negative for the user to identify. However, these signs may be covered by dust after a period of time and will be difficult to identify.

Another prior art is to form a pair of recesses around conducting terminals and filled with different colors. These colors are mostly oily and contain poison material. It is particularly dangerous for recycling and affects the environment. Thus this product is not conformable with environment requirement, and is harmful to human health. The oily colors can hardly achieve real tightness with the recesses and may be detached after a period of time.

### SUMMARY OF THE INVENTION

It is the primary object of the present invention to provide a battery cover structure to identify the positive and negative poles of a battery, which is easy to install.

It is another object of the present invention to provide a battery cover structure to identify the positive and negative poles of a battery, which is easy to identify.

It is a further object of the present invention to provide a battery cover structure to identify the positive and negative poles of a battery, which lowers the mistake made by human.

It is still a further object of the present invention to provide a battery cover structure to identify the positive and negative poles of a battery, which is formed with an injection method and will never deteriorate so as to conformity with environment requirement.

### BRIEF DESCRIPTION OF THE DRAWINGS

FIG. 1 is a perspective view of the present invention;

FIG. 2 is a perspective view of the present invention incorporated onto a battery;

FIG. 3 is a perspective view of a second embodiment of the present invention;

FIG. 4 is a top view of a battery cover of prior art; and

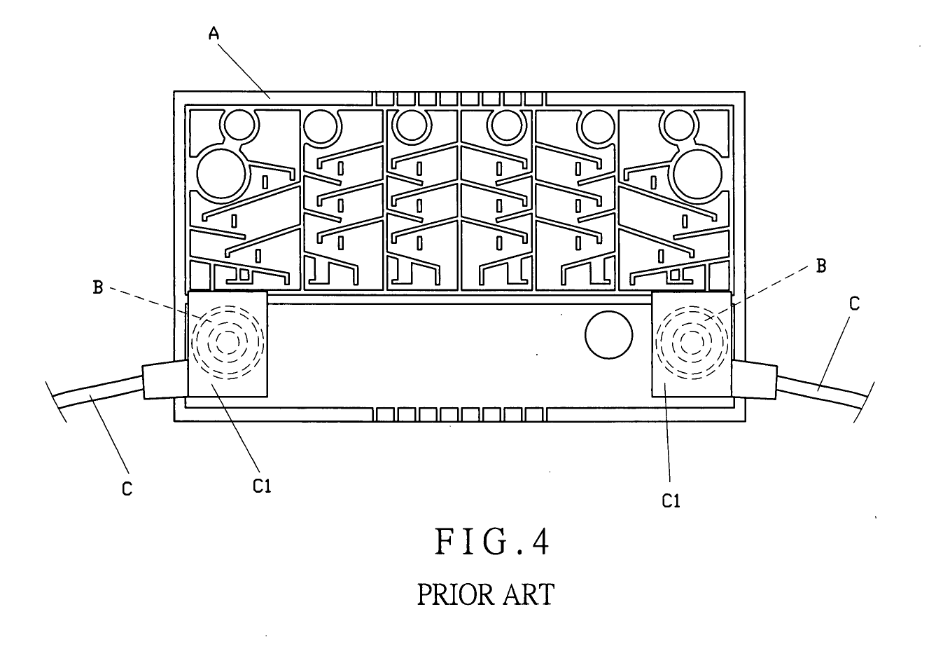

FIG. 5 is a top view of another battery cover of prior art.

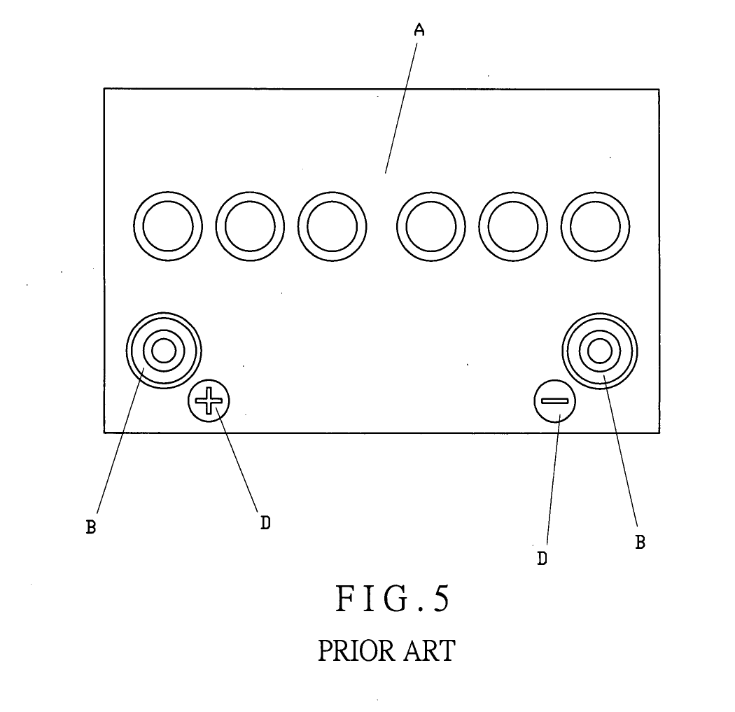

### DETAILED DESCRIPTION OF THE PREFERRED EMBODIMENTS

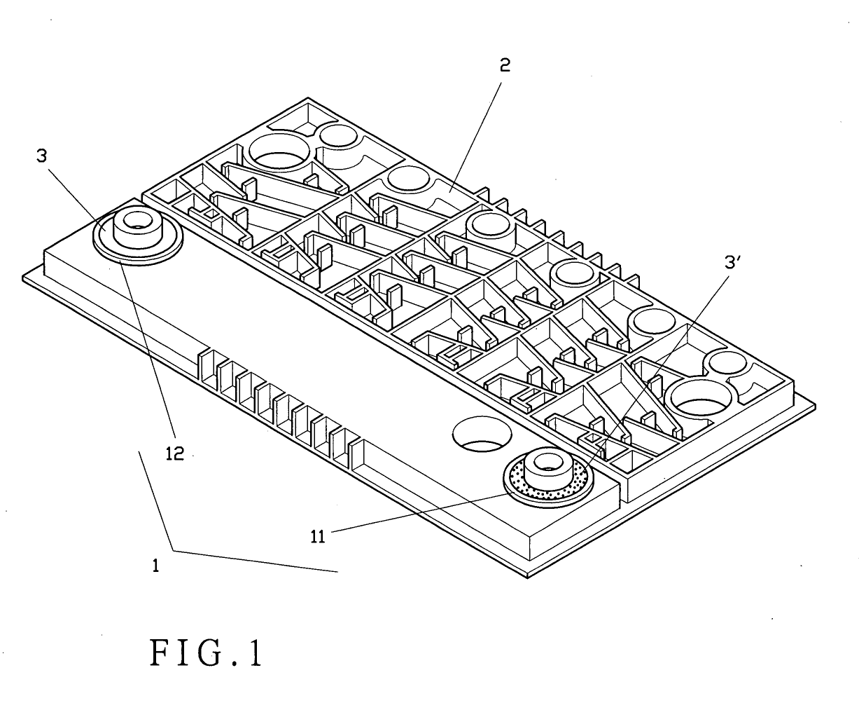

A battery cover with a conducting terminal set 1, as shown in FIG. 1, comprises insulating plastics material 2. The conducting terminal set 1 is embedded in a mold and different colors are also embedded in the mold next to the conducting terminal set 1. The whole set is injected through the mold to form a battery cover with different colors formed next to the positive and negative poles for identification purpose. The conducting terminal set 1 comprises a first conducting terminal 11 and a second conducting terminal 12. A red warning color 3′ is located close to the first conducting terminal 11 and a black warning color 3 is located next to the negative terminal 12.

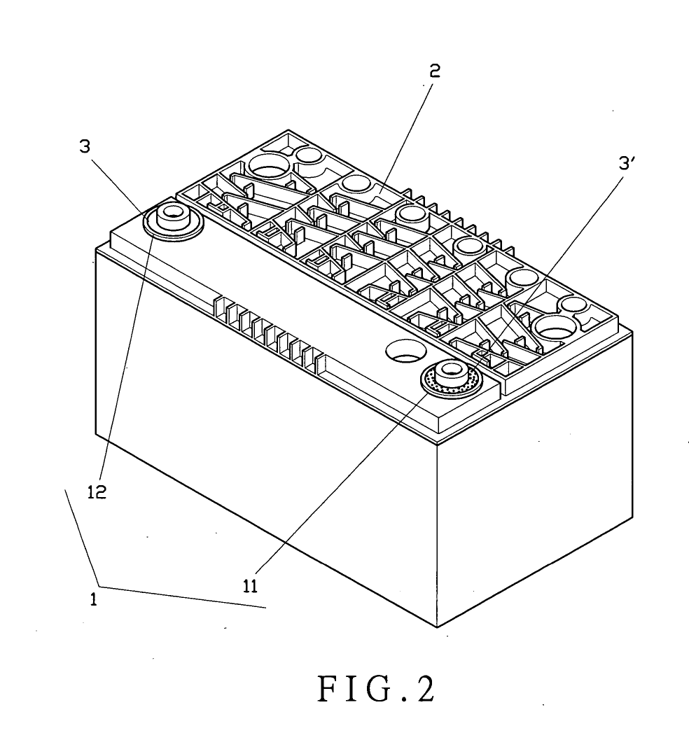

To operate the present invention, as shown in FIG. 2, the battery cover is placed onto a battery. The red and the black colors 3′ and 3 affiliate recognition of which is the positive pole and which is the negative pole so that the user realizes that the red warning color 3′ has a high voltage output, while the black warning color 3 has a low voltage output, therefore, it is easy to make a safe and correct connection. Since the colors are embedded in the insulating material, they will last forever.

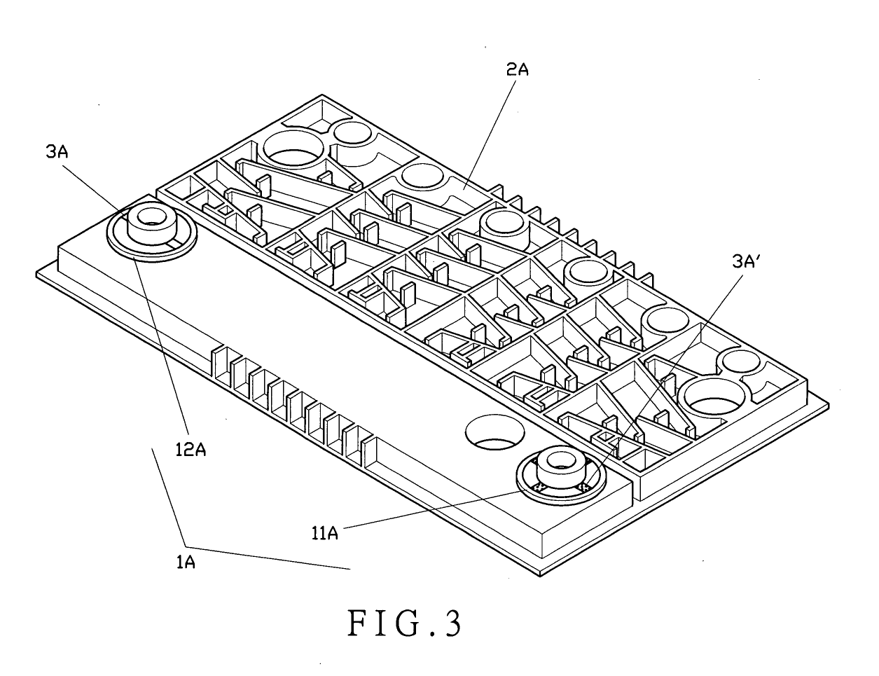

FIG. 3 shows another embodiment of the present invention, which has embedded insulating plastics material 2A onto a conducting terminal set 1A and different colors are located next to the conducting terminal set 1A for identification purpose as which is the positive pole and which is the negative pole. A first conducting terminal 11A is embedded with red warning color 3A′ and a second conducting terminal 12A is embedded with black warning color 3A. The warning colors may be embedded into the conducting terminal set 1A directly. A combination of warning colors may also be adapted for identification. In this case, even the battery is located at a darker area, it is still easy to identify.

When the warning color 3A′ is red, the user immediately knows that the first conducting terminal 11A is the positive pole which outputs a high voltage and should be connected to a high voltage end. Contrary, if the warning color 3A is black, the second conducting terminal 12A is the negative pole which outputs a low voltage. This design eliminates any mistake. The colors embedded into the terminal set 1A will last forever and will not be faded.

What is claimed is:

1. A battery cover structure to identify the positive and negative poles of a battery, being provided with identifiers next to conducting terminals, and characterized by:
said identifiers to identify the positive or negative poles being made with insulating plastics material in different colors formed on a battery cover by an injection method.

2. The battery cover structure to identify the positive and negative poles of a battery, being provided with identifiers next to conducting terminals, and characterized by:
said identifiers to identify the positive or negative poles being made with insulating plastics material in different colors and shapes formed on a battery cover by an injection method.
